(19) United States
(12) Patent Application Publication
(10) Pub. No.: US 2004/0153837 A1
(43) Pub. Date: Aug. 5, 2004

(54) Automated testing

(75) Inventors: Adrian James Preston, Southampton (GB); James Clive Stewart, Evesham (GB)

Correspondence Address: IBM Corp., IP Law, 11400 Burnett Road, Zip 4054, Austin, TX, 78758, US

(73) Assignee: INTERNATIONAL BUSINESS MACHINES CORPORATION, ARMONK, NY (US)

(21) Appl. No.: 10/660,011

(22) Filed: Sep. 11, 2003

(30) Foreign Application Priority Data
Sep. 13, 2002 (GB) 0221257.9

(51) Int. Cl. H04B 1/74

(52) U.S. Cl. 714/39

(57) ABSTRACT

A system for recording for reuse, at least one test event and at least one associated response. A testing program sends one or more test events (e.g. button click) to a component (e.g. a web browser software application) and receives an associated response from the component (e.g. associated button is clicked). A tracing program stores test events and responses in a trace file and an analyser program analyses the file and creates “situations” of test events and associated responses. If required, the situations are further processed by an extractor program, which extracts surplus test events that are not required in order to produce an associated response. This extracting process produces a minimum set of test events, and the minimum sets and associated response are stored for reuse.

### FIELD OF THE INVENTION

The present invention relates to the field of automated testing.

### BACKGROUND OF THE INVENTION

It is vital to ensure that a product or system is fully operational and consistently performs according to its functional specification before it is made available to the public. The reliability of computer software/hardware is especially important since computers form the backbone of an increasingly large number of organisations. When a computer system fails to respond as intended, businesses are invariably unable to provide even the most basic of services. Money, reputation or even lives may be lost, dependant upon the criticality of the service, the outage time etc.

In today's increasingly competitive market-place, quality and reliability are of the utmost importance. Customers do not tolerate mistakes and the later a defect is discovered, the more costly it can prove to the manufacturer. Furthermore, software is undergoing a revolution in terms of complexity from a test perspective and the majority of today's software relies on testing software for its development. Exhaustive testing is impractical, if not impossible, but what is important however is that a computer system is subjected to as many operational scenarios as is feasible. Any resulting problems can then be corrected before the system is released.

Typically, these operational scenarios may be simulated using a large number of small computer programs known as test cases. Each test case, within an overall test suite, is designed to test a different aspect of the system. A test harness is used to run the suite of test cases as well as performing other tasks such as finding test cases in a directory tree and producing a report describing which test cases passed and which ones failed.

A test plan is a set of test cases plus any other additional information that may be required to complete the testing, such as the required environment and context. Preferably, the plan should be derived as accurately and completely as possible from the functional specification of the system/software under test. Testing against a functional specification requires the system and/or software under test to be driven through a sequence of states. The test plan should ensure that every specification item is “covered” by a test case.

In order to manually test a system and/or software, a tester must hard code each test case. Manual testing is advantageous if the tester has knowledge of the system/software under test, the number of test cases is small and limited in scope and test results are required quickly.

Automated software testing typically involves a tool that automatically enters a predetermined set of characters or user commands in order to test a system/software. The automation of software testing is necessary due to several factors, such as rapid delivery and reliability of software products. “Silktest” from Segue Software, Inc. and “Winrunner” from Mercury Interactive are tools that automatically test GUIs. The tools automate the process of interacting with the GUI (e.g. a web browser). The tools can either record user interactions with the GUI, or be programmed to reproduce user interactions with the GUI. In other words, the tools emulate a user at a keyboard and screen.

Automation has several advantages over manual testing. For example, when performing manual tests, a human tester needs to understand and be familiar with the system/software under test, which requires a high level of programming skill. Automation allows for testing of a larger proportion of the system/software under test with more efficiency and speed than manual testing. Furthermore, fewer testers need to be employed in order to execute automated tests.

However, there are still disadvantages and difficulties associated with automated testing. For example, a tester must resolve the trade off between cost and effort of automation versus the implementation of manual testing. For example, when automating testing of a Graphical User Interface (GUI), the tester typically needs to define the test case; set up and practise the test case; store the test case; edit it to add error handling etc.; maintain the test case whenever the GUI is changed; run the test case periodically; check the results and investigate any test cases which fail. This procedure generally requires more effort to plan and organise than running the test case manually.

A high proportion of software is designed for reuse in heterogeneous environments (differing operating systems, database types, user interfaces, communications layers etc.). For every combination of software and environment, re-testing of that software is required. Therefore, the sheer numbers of possible states (and therefore test cases) of the software that may arise contribute to an ongoing and rapid explosion in the amount of work involved in testing software.

Systems and software are prone to extensive change during development and between releases. The effort in automating tests is often not reusable when system configuration changes; between different releases of software or between different environments because if these changes include new or changed functions or parameters, each associated test case must be revised and this results in a considerable maintenance overhead. For this reason, test tools are often used early in the development cycle by developers keen to use automation, only to be discarded towards the end of the cycle or during development of the next release of software, because of the problem of maintenance.

Thus, there is a need for a reduction in the maintenance overhead for testers, especially in cases where functions and parameters associated with the software under test are to change frequently. There is also a need to be able to re-use the effort involved in automating test cases.

Furthermore, there is a need for a technique with features to emulate the good practices of human testers, such as being able to cope when information is inadequate, incomplete or invalid; and identifying strategies that apply to a particular scenario so that this information can be shared with other similar systems and with other human testers.

### SUMMARY OF THE INVENTION

According to a first aspect, the present invention provides a system for recording for reuse, at least one test event and at least one associated response, said system comprising: an application program for testing at least one function of a component to be tested: a communication protocol for sending by said application program, said at least one test event to said component and receiving from said component, said at least one associated response; storage for storing by a tracer, said at least one test event and said at least one associated response, in a trace file; an analyser for analysing said trace file; an extractor for extracting at least one minimum set of test events from said trace file, wherein said at least one minimum set generates said at least one associated response; and said storage being further adapted to store said at least one minimum set and said at least one associated response. Advantageously, reusable sets of test events and associated responses are stored, so that test case can be re-created in differing environments without the need for constant maintenance.

Preferably, the analyser comprises means for determining whether the trace file is empty, means for parsing test events and means for creating at least one “situation”. Each situation comprises a minimum set of events and an associated response. A database of situations can be created, so that a tester has a set of generic test cases to hand which can be re-used across heterogeneous systems

In a preferred embodiment, the extractor iteratively analyses the stored situations to remove intervening test events one at a time. The associated situation is tested each time by the analyzer to ensure that the refined situation still works. The resulting situation data is now more general.

It is an advantage of the present invention to allow two or more situations to share test events. Preferably, if a shared test event generates two or more associated responses a rule is invoked whereby only one associated situation overrides.

According to a second aspect, the present invention provides a method for recording for reuse, at least one test event and at least one associated response, for use in a system comprising: an application program for testing at least one function of a component to be tested, said method comprising the steps of: sending by said application program, said at least one test event to said component and receiving from said component, said at least one associated response; storing said at least one test event and said at least one associated response in a trace file; analysing said trace file; extracting at least one minimum set of test events from said trace file, wherein said at least one minimum set generates said at least one associated response; and storing said at least one minimum set and said at least one associated response.

According to a third aspect, the present invention provides a computer program comprising program code means adapted to perform all the steps of the method as described above when said program is run on a computer.

### BRIEF DESCRIPTION OF THE DRAWINGS

The present invention will now be described, by way of example only, with reference to preferred embodiments thereof, as illustrated in the following drawings:

FIG. 1 shows a pictorial representation of a distributed data processing system;

FIG. 2A shows a simplified overview of a prior art automated test system;

FIG. 2B shows a representation of a prior art test case;

FIG. 3 is a flow chart showing the operational steps involved in a prior art process of recording and playback;

FIG. 4 is an example of a “situation” in accordance with the present invention;

FIG. 5A is an overview of an automated test system, in accordance with the present invention;

FIG. 5B is a flow chart showing the operational steps involved in a process of creating situations, implemented in the system of FIG. 5A;

FIG. 6 is a flow chart showing the operational steps involved a process to resolve conflicts upon re-play of a trace, in accordance with the present invention;

FIG. 7 is a flow chart showing the operational steps involved in a process to resolve conflicts that occur when implementing the process of FIG. 5B; and

FIG. 8 is an example of a “goal”, in accordance with the present invention.

### DETAILED DESCRIPTION OF THE INVENTION

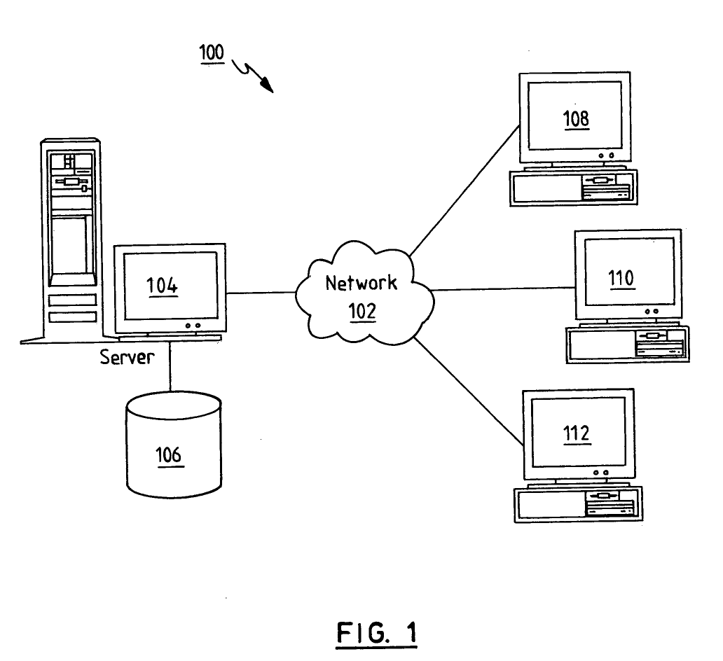

FIG. 1 shows a pictorial representation of a distributed data processing system in which the present invention may be implemented. The distributed data processing system (100) comprises a number of computers, connected by a network (102), which could be, for example, the Internet. A server computer (104) is connected to the network (102) along with client computers (108), (110) and (112). The server computer (104) has an associated storage unit (106).

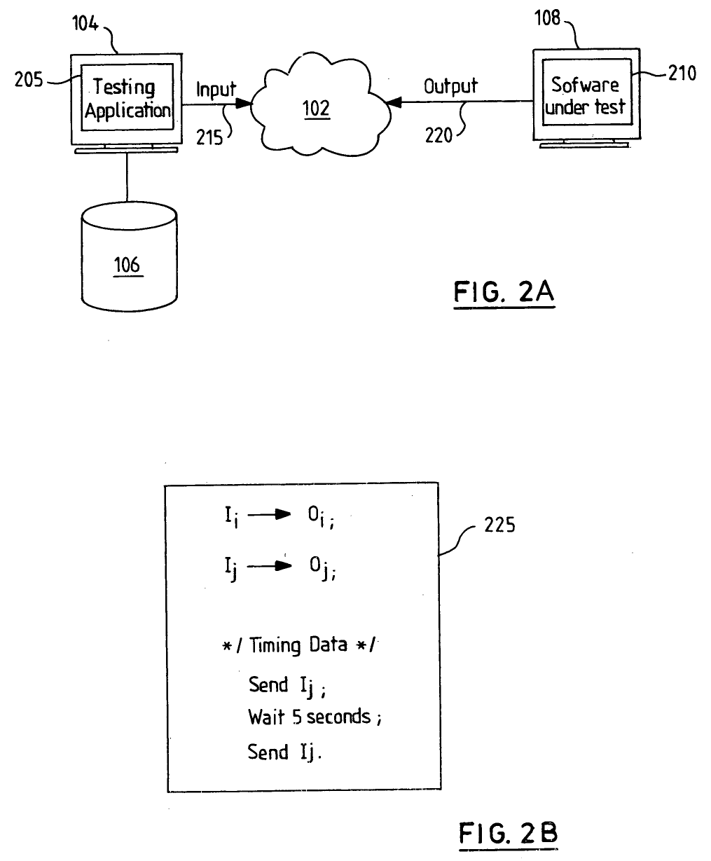

FIG. 2A shows a simplified overview of a prior art automated test system (200) implemented using the distributed data processing system of FIG. 1. The server computer (104) comprises an automated testing application (205) and an associated storage unit (106) that is used for logging. The server computer (104) controls the testing of software (210) residing on a system under test, in this case, client computer (108). In a more complex example, a system under test can comprise many hardware and/or software components, networked machines, interfaces etc.

Some of the important concepts associated with automated testing will now be described with reference to FIG. 2A. Typically, the testing application (205) sends an input event (215) to the software under test (210) and in response, receives an output event (220) from the software under test (210). The output event (220) is logged in the storage unit (106) and serves as a basis for sending another input event to the software under test (210). The testing application (205) and the software under test (210) are subject to a sequence of alternating input events and output events.

Input events and output events are typically textual strings but can also be messages, user interface actions etc. For example, if the software under test (210) is a GUI, the input event (215) is a GUI action, e.g. a button click. In response to the input event (215), the software under test (210) produces an output event (220) e.g. confirmation that the button is clicked. More detail such as associated timing information and local variable names may be required in order to execute test cases. These details can be represented by using additional data attached to each input event and output event.

As shown in FIG. 2B, a test case (225) may comprise one or more sequences of input events and output events and any other information required to execute that test case (e.g. associated timing information). A test case is executed when the final output event (in this case, Oⱼ) is executed.

If several input events need to be sent to the software under test before an output event is received, or if several output events need to be sent to the testing application before a final output event is produced, the input events (or output events) can be aggregated into a single “message”. Interaction between the testing application and the software under test can be thought of as a two-way “conversation”, comprising alternating messages, whereby each message may comprise one or more input events or one or more output events. Each conversation moves the software under test from some starting state to an end state, through a sequence of intermediate states. An example of a fragment of a conversation is shown below:

| | |
|---|---|
| Testing application: | Select “File” menu; |
| Software under test: | File menu surfaced; |
| Testing application: | Select “Open” sub-menu; |
| Software under test: | “Open” sub-menu surfaced; |
| Testing application: | Select file “X”; |
| Software under test: | File “X” selected within |
| | “Open” sub-menu; |
| Testing application: | Press “Open” button; |

A “trace” is defined as a historical record of a conversation as seen from the perspective of the tester. A trace is recorded by a tracing program and is stored in a trace file.

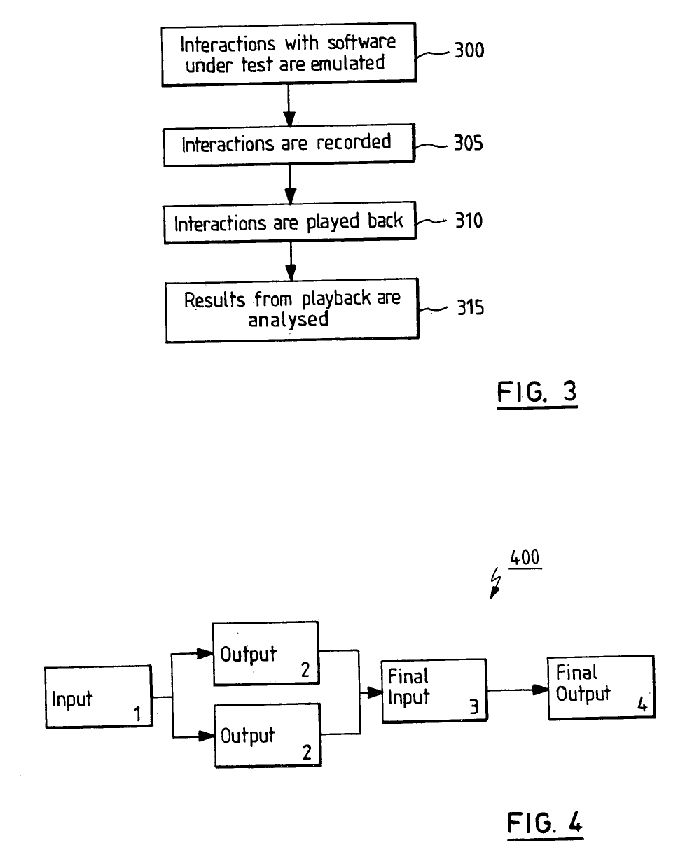

One embodiment of the prior art record/playback concept associated with automated testing will now be described with reference to FIG. 3. A user's interactions with the software under test (e.g. button click) are emulated (step 300). The interactions are input events and are usually in the form of scripts. The emulation step can either be carried out by a tester or an automated testing tool can be pre-programmed with user interactions, user commands etc. Next, these interactions are “recorded” (step 305) i.e. logged and stored (for example, in a storage unit such as 106).

In order to execute a test of a function (e.g. the click of a button) of the software under test, the recorded interactions are automatically “played back” (step 310) i.e. the input events are sent to the software under test. Following playback, the results (i.e. output events from the software under test) are received and then analysed (step 315). An automated test tool can re-play interactions continuously, whilst storing results from each re-play for analysis.

In the prior art, if continuous and major changes are made to the software under test, test cases will need updating to cope. This process is time consuming especially in an environment requiring rapid results.

Accordingly, the present invention provides a method of analysing a trace file and extracting the minimum amount of events that need to occur in order to execute a test case (i.e. to produce an output event from the system and/or software under test). Advantageously, this minimum amount of information can be reusable in any environment since the tester can configure the base set of events with environment-specific details (e.g. whereby the operating system is “AIX” (AIX is a registered trademark of International Business Machines Corporation)). The minimum set of events is extracted from the trace file, since this is the most reusable and applicable form.

A. Situations

A trace is a record of a sequence of alternating input and output events, for example:

Input 1, Output 1, Input 2, Output 2, Input 1, Output 3

Since the events in a trace are sequential, the order in which the events occur is important. However, the related events need not be contiguous in the trace.

According to the present invention, a minimum set of events that is required in order to produce an output event is extracted. The events required to uniquely identify an output event will occur before that output event in a trace. In a simple example, the event that immediately precedes an output event, predicts that output event uniquely in a trace. However, more complex patterns of events are possible, whereby a unique sequence of events occurs immediately before every occurrence of a particular output event.

The unique event or sequence of events that produce a particular output event, together with the output event itself is referred to herein as a “situation”. Situations can be logged in a knowledge base to facilitate future analysis and reuse. Each situation will only progress whenever the expected event occurs. When the last expected event in the sequence arrives, a final output event is produced. More complex models could be established, for example, where time delays are incorporated between events.

A situation typically comprises:

1. A start event—this is either an input event or an output event and triggers a situation to start

2. Intermediate event—there can be multiple intermediate events present

3. An end event—the event that immediately precedes the final output event

4. A final output event

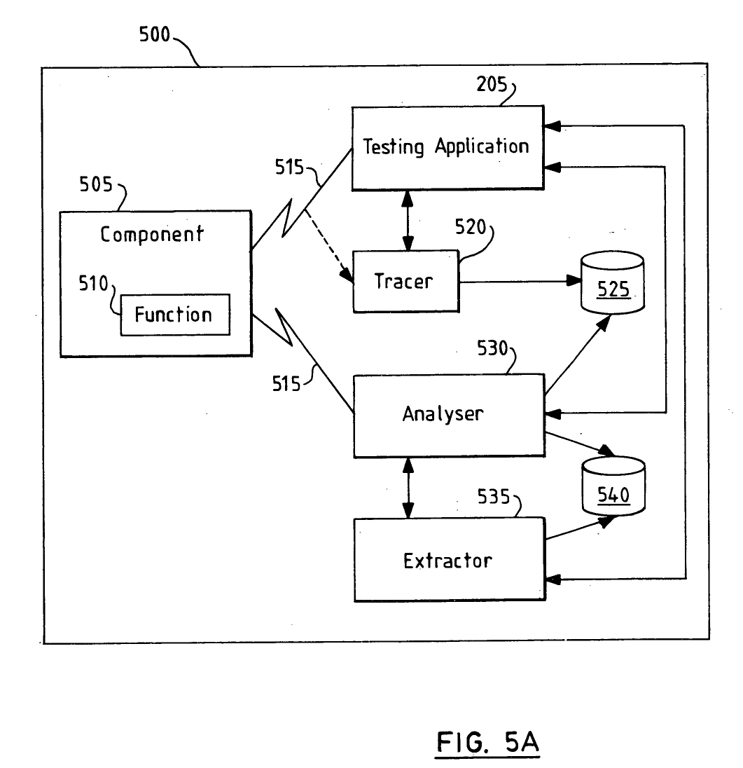

An example of a situation (400) is shown in FIG. 4. The type of each event is shown with reference to the above numerals.

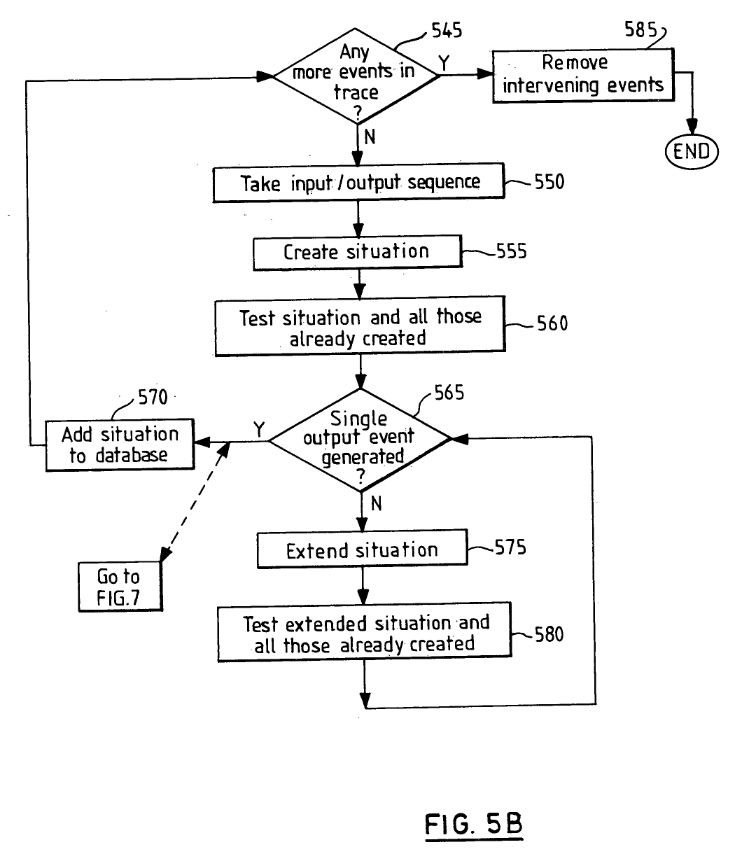

A method for determining the minimum set of events required in order to produce a final output event according to the present invention, will now be described, with reference to FIGS. 5A and 5B.

Referring to FIG. 5A, there is a shown a test system (500) wherein a testing application (205) tests a function (510) of a component (505). A component can be either a hardware component (e.g. a whole computer system, a hard drive, a client computer (108) etc.) or a software component (e.g. transaction processing software, messaging software, the software under test (210) etc.). Examples of testing a function of a hardware component comprise: powering on a floppy disk drive, powering down a printer, receiving data from a motherboard etc. Examples of testing a function of a software component comprise: setting the time on a system clock, clicking a button within a GUI etc.

In order to test a function, input events are sent from the testing application (205), over a communication protocol (515) (e.g. SSL in a distributed environment or a shared memory data structure in a local environment), to the component (505). Output events from the component (505) are then received. A record (i.e. a trace) of the data exchanged between the testing application (205) and the component (505) is stored in a trace file by a tracing program (520). The trace file resides on a database (525). The stored trace and trace file can then be analysed in the future.

Before the process of FIG. 5B is executed, a trace for analysis is obtained from database 525. In this example, the stored trace is shown below:

“Input 1 (I₁), Output 1 (O₁), Input 2 (I₂), Output 2 (O₂), Input 1 (I₁), Output 3 (O₃)”

Referring to FIG. 5B, in step 545, an analyser program (530), determines whether the trace comprises any events. In this case the trace is not empty and the process passes to step 550, where the analyser (530) parses the first input event and output event (i.e. I₁ and O₁). In step 555, the analyser (530) creates a “situation” comprising I₁ and O₁ (for example purposes, in notation form, the situation is: I₁>O₁). This situation is a record that tells the testing application (205) that if an input event (I₁) is sent, an output event (O₁) must be produced.

Processing passes to step 560, where the analyser (530) tests the situation and any other situations that have been created. In this case, only one situation has been created so far, namely, I₁>O₁. The situation is tested by using playback, wherein each input event is sent to the component (505), in turn. The testing application (205) then waits until the associated output event is produced. In this example, sending an input event (I₁) produces an output event (O₁). In step 565, the analyser (530) determines whether a single output event has been generated in response to the testing process at step 560 and in this case, a positive result is returned. Therefore, the processing passes to step 570, where the analyser (530) adds the tested situation to an associated database (540).

The process returns to step 545, and since the trace comprises events, at step 550, the next input event and output event (i.e. I₂ and O₂) are parsed. In step 555, a “situation” comprising I₂ and O₂ is created, namely, I₂>O₂. Processing passes to step 560, where the created situation and any other situations that have been created are tested. In this case, two situations are tested, namely, I₁>O₁ and I₂>O₂. Thus, sending an input event (I₁) produces an output event (O₁) and sending an input event (I₂) produces an output event (O₂). Since a single output event has been produced for each of the input events sent to the component (505), a positive result is returned in step 565 and the processing passes to step 570 where the created situation (I₂>O₂) is added to the database (540).

The process returns to step 545, and since the trace comprises events, at step 550, the next input event and output event (i.e. I₁ and O₃) are parsed. In step 555, a “situation” comprising I₁ and O₃ is created, namely, I₁>O₃. Processing passes to step 560 and in this case, three situations are tested, namely, I₁>O₁; I₂>O₂ and I₁>O₃. Sending an input event (I₁) produces an output event (O₁), sending an input event (I₂) produces an output event (O₂) and sending an input event (I₁) produces two output events, namely, O₁ and O₃. Since two output events (O₁ and O₃) have been produced, in response to a negative result at step 565, processing passes to step 575.

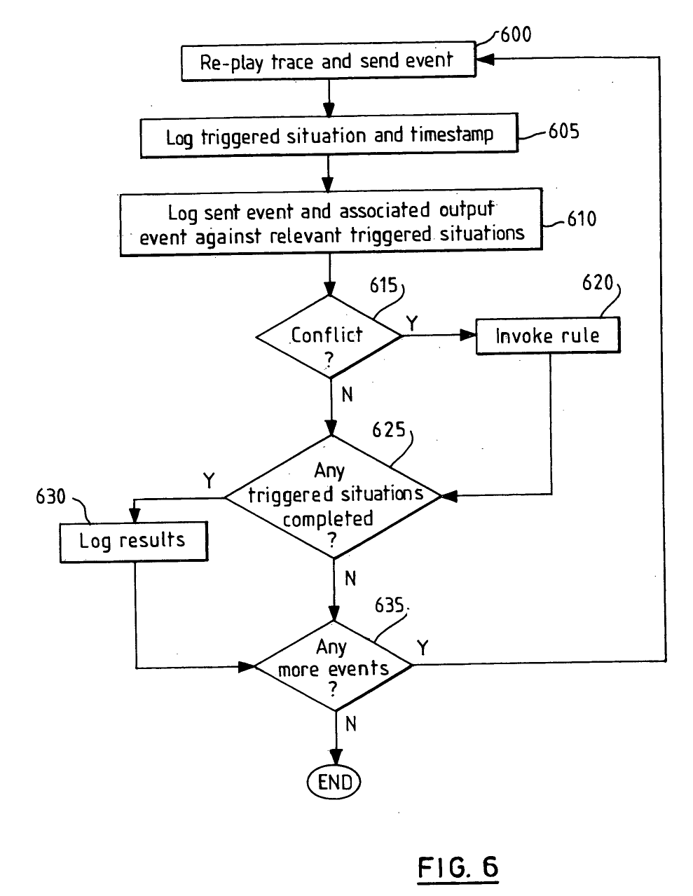

At step 575, the situation (I₁>O₃) is extended by adding the previous input event that had occurred in the trace, namely, Input 2 (I₂). This creates an extended situation, namely, I₂+I₁>O₃. It should be noted that the situations I₂>O₂ and I₂+I₁>O₃ now share the event Input 2 (I₂). There is a problem associated with event sharing and a process needs to be executed in order to deal with this. This process is described with reference to FIG. 6.

Referring back to FIG. 5B, at step 580, the extended situation is now tested, together with any other situations that have been created. In this case, sending an input event (I₁) produces an output event (O₁). Sending an input event (I₂) produces an output event (O₂), however, since the extended situation is sharing input event (I₂), the extended situation (I₂+I₁>O₃) has also been triggered to progress and is waiting for its next input event (I₁). When the next input event in the trace, namely I₁, is sent to the component (505), an output event (O₃) is produced. The process passes to step 565 and since a single output event has been produced for each of the input events sent to the component (505), a positive result is returned at step 565 and the processing passes to step 570 where the extended situation (I₂+I₁>O₃) is added to the database (540).

At step 575, adding the immediately preceding input event that had occurred in the trace extends the situation. It should be understood that in practice, this process may have to be executed and tested (at step 580), iteratively, until a single output event is generated.

The process returns to step 545, and since the trace comprises no more events, processing passes to step 585. At this step, a further process is carried out on the situations in the database (540) by an extractor program (535), in order to remove surplus events that are not required to uniquely predict an associated output event. An example of a surplus event is “click on a first frame in a web page”. Since not all systems support frames, this event cannot be re-used across environments and therefore it should be removed from the database (540). At step 585, intervening events are removed one at a time and the situation is tested each time by the analyzer (530), to ensure that the situation still works. Therefore, the refined situation data is more general and can now be stored for reuse in the database (540).

Advantageously, the refined data is re-usable and can be used in differing environments. For example, a tester testing Version 2.0 of “SOFTWARE X” can utilize a bank of stored situations relating to features that Version 2.0 has in common with Version 1.0. In another example of promoting reuse, if an unexpected response is received from the component (505), in a distributed environment, stored situations residing on other systems can be searched in order to determine the unique sequence of events required in order to replicate the unexpected response.

Once situations have been created, the original trace (stored in database 525) from which they arose can be played back again in order to test whether expected responses are obtained from the component (505). The trace can be re-played in other environments (e.g. differing operating systems, hardware etc) and the results can be analysed. Upon re-playing of the trace, the testing application (205) needs to know which output responses have been generated by the component (505), in order to log them in a test results log. Conflicts can occur when two situations share an event.

FIG. 6 is a flow chart showing the operational steps involved in a process for dealing with conflicts due to event sharing. Following the processes described with reference to FIGS. 5A and 5B, the testing application (205) has the following information to hand:

Original trace stored in database 525:

“Input 1 (I₁), Output 1 (O₁), Input 2 (I₂), Output 2 (O₂), Input 1 (I₁), Output 3 (O₃)”

Situations logged in database 540:

Situation 1 (I₁>O₁);

Situation 2 (I₂>O₂);

Situation 3 (I₂+I₁>O₃)

Upon re-play of the trace above, input events are sent to the component (505) and output events are received. In step 600, the trace is re-played and the first event (namely, I₁) is sent. I₁ is a start event and the situations that it has triggered (this is known from searching database 540) are logged and time stamped in step 605. In this case, I₁ has triggered Situation 1 and the time stamp is “15:00”. In step 610, the input event is logged against the relevant triggered situations, in this case, I₁ is logged against Situation 1. An output event (namely, O₁) is received from the component (505) and this is logged against Situation 1. The log is shown below:

Log

Situation 1 (15:00)—I₁; O₁

In step 615, a determination is made as to whether a conflict occurs. In this case, since a single output event (i.e. response) has been produced, the process passes to step 625. A determination is made as to whether any of the triggered situations have completed and in this case, in response to a positive result, the process passes to step 630. At this step, it is logged that the component (505) has produced the expected output event O₁, in response to input event I₁ being sent and therefore, Situation 1 has completed successfully. The log is shown below:

Log

Situation 1 (15:00)—I₁; O₁ Completed successfully

The process now passes to step 635, where a determination is made as to whether there are any more input events in the trace and in this case, since there are more input events, the process passes back to step 600.

When the trace is re-played at step 600, the next input event (namely, I₂) is sent. The database (540) of situations is searched in order to determine the situations that have been triggered. In this case, I₂ has triggered Situation 2 and Situation 3 and the time stamp is “15:15”.

In step 610, the input event is logged against the triggered situations. In this case, I₂ is logged against Situation 2 and Situation 3. An output event (namely, O₂) is received from the component (505) and this is logged against Situation 2. The log is shown below:

Log

Situation 1 (15:00)—I₁; O₁ Completed successfully

Situation 2 (15:15)—I₂; O₂

Situation 3 (15:15)—I₂

In step 615, a determination is made as to whether a conflict occurs. In this case, since a single output event (i.e. response) has been produced, the process passes to step 625. A determination is made as to whether any of the triggered situations have completed and in this case, in response to a positive result, the process passes to step 630, where it is logged that the component (505) has produced the expected output event O₂, in response to input event I₂ being sent and therefore, the Situation 2 has completed successfully. The log is shown below:

Log

Situation 1 (15:00)—I₁; O₁ Completed successfully

Situation 2 (15:15)—I₂; O₂ Completed successfully

Situation 3 (15:15)—I₂

The process now passes to step 635, where it is determined that there more input events in the trace and therefore, the process returns to step 600.

When the trace is re-played at step 600, the next input event (namely, I₁) is sent. The database (540) of situations is searched in order to determine the situations that have been triggered. In this case, I₁ has triggered Situation 1 again, and the time stamp is “15:30”. However, I₁ is also required in order to complete Situation 3.

In step 610, the input event is logged against the triggered situations. In this case, I₁ is logged against Situation 3 and a second instance of Situation 1. Two output events (namely, O₁ and O₃) are received from the component (505) and these are logged against the relevant situations. The log is shown below:

Log

Situation 1 (15:00)—I₁; O₁ Completed successfully

Situation 2 (15:15)—I₂; O₂ Completed successfully

Situation 3 (15:15)—I₂; I₁; O₃

Situation 1 (15:30)—I₁; O₁

In step 615, a determination is made as to whether a conflict occurs. In this case a conflict has arisen since the testing application (205) is faced with the possibility of two output events from the component (505). Therefore, the testing application does not know what to log in the test results (at step 630), that is, whether Situation 3 has completed, or whether a second instance of Situation 1 has completed.

Therefore, processing passes to step 620, wherein a rule for dealing with the conflicts is invoked. In this embodiment, the rule for dealing with this complexity is that the “longer running” situation overrides. In this case, Situation 3, which has an earlier timestamp (“15:15”) than the second instance of Situation 1 (“15:30”), overrides. The process passes to step 625, where it is determined by the testing application, that Situation 3 has completed. The results are logged in step 630 and the data associated with the second instance of Situation 1 is deleted from the log. The log is shown below:

Log

Situation 1 (15:00)—I₁; O₁ Completed successfully

Situation 2 (15:15)—I₂; O₂ Completed successfully

Situation 3 (15:15)—I₂; I₁; O₃ Completed successfully

However, it should be understood that in the record of re-play, the second instance of O₁ (and therefore Situation 1), remains. If when implementing the present invention, the “sharing events” function is enabled, when the records are analysed, the second instance is simply overridden. The process now passes to step 635 and since there are no more input events in the trace, the process ends.

FIG. 6 is one embodiment of dealing with sharing events. In another embodiment, the sharing events function can be disabled altogether. Furthermore, in the FIG. 6 embodiment, overlapping has been handled by invoking a rule that enables the “longer running” situation to override. It should be understood that many types of different rules could be invoked in alternative embodiments. For example, a rule that enables the most frequently used situation or the shortest running situation to override can be invoked.

Identical events will sometimes produce differing final output events. For example a portion of a trace is shown below:

I_{A}, O_{B}, I_{A}, O_{Z}

By implementing the method of FIG. 5B, two situations are created, namely, I_{A}>O_{B} and I_{A}>O_{Z}. There is now a conflict in that the same start event is producing two different final output events. Therefore, if the situations were added to the database (540) in step 570, there would be no way of distinguishing between the situations. This is a problem when trying to extract “unique” situations, because in this example, the same event produces final output events “B” and “Z”. When storing situations in a knowledge base, it is important that a unique output event is produced in response to a unique sequence of events, as this is the most re-usable form.

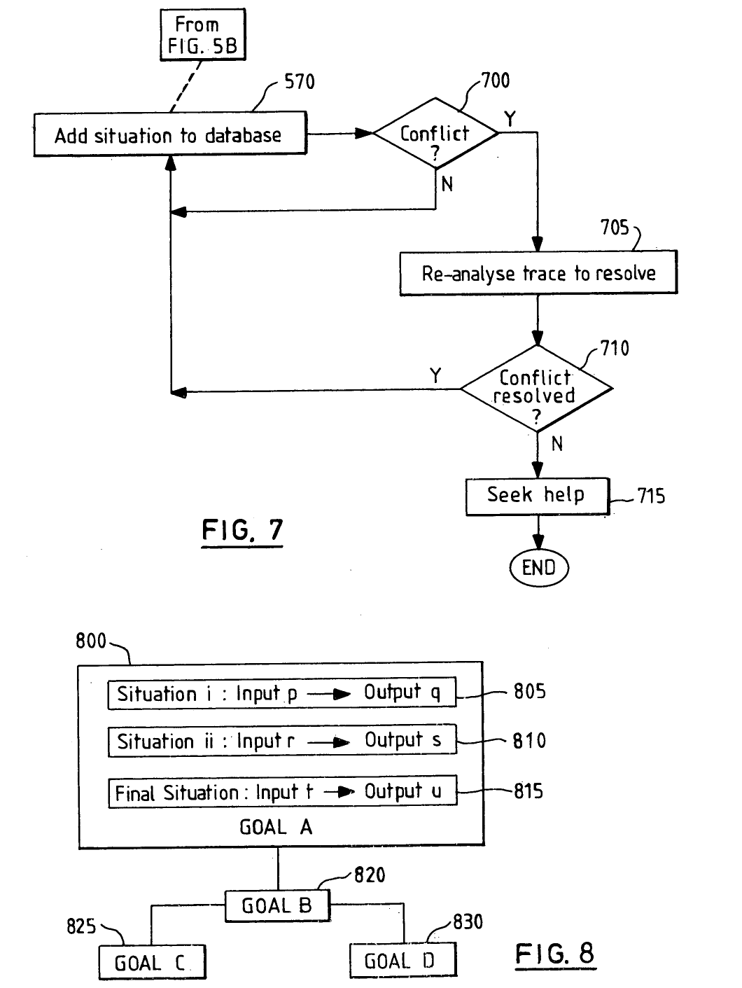

The process for dealing with this conflict is described in more detail with reference to FIG. 7. On the first pass through the process of FIG. 5B, situation I_{A}>O_{B} is added (step 570) to the database (540). On the second pass through FIG. 5B, before situation I_{A}>O_{Z} is added to the database (540), the processing passes to FIG. 7. At step 700, a determination to check whether a conflict would arise if situation I_{A}>O_{Z} was added to the database (540).

If it is determined that a conflict would not occur (negative result to step 700), the situation is added (step 570) to the database (540). However, in this case, it is determined that a conflict would occur (positive result to step 700), since the same input event is producing two different output events. Therefore, the processing passes to step 705 and the trace is re-analysed in order to resolve the conflict. The re-analysis identifies whether a previous unique sequence of events for situation I_{A}>O_{Z} has occurred in the trace. For example purposes, another portion of the trace is analysed:

I_{X}, O_{Y}, I_{A}, O_{Z}

Therefore, from the above portion, it can be seen that a sequence of events (I_{X}, O_{Y}, I_{A}) to uniquely predict O_{Z} has occurred previously. Processing now passes to step 710, which determines whether the conflict has been resolved. In this case, in response to a positive result, situation I_{X}+O_{Y}+I_{A}>O_{Z} is added (step 570) to the database (540). However, if by tracking back through the trace, the conflict has not been resolved (negative result to step 710) then the testing application (205) seeks (step 715) help from elsewhere.

B. Goals:

In order to test a function, several situations may need to occur before a final output event is produced. For example, in order to save work in a computer system, the following actions will have to be executed:

“Open “File” menu”;

“Click on “save” option”

Sets of situation can be grouped into “goals”. In the example above, the goal is “Save work”, the situations are “Open “File” menu” and “Click on “save” option” and the final output event is “Work has been saved.”

Completion of multiple goals in sequence may be required in order to test a function and therefore goals can be nested. Referring to FIG. 8, there is shown a hierarchy of goals. Goal “A” (800) comprises Situation “i” (805), Situation “ii” (810) and a final situation (815). All the situations have associated input and output events. Before completion of Goal “A” (800), Goal “B” (820) must complete. Before completion of Goal “B” (820), Goal “C” (825) and Goal “D” (830) must complete. Each goal completes when the final situation in the set associated with that goal completes e.g. For Goal “A”, an input event “t” must produce a final output event “u”.

Another example of a nested goal is shown below. The example below details some of the stages required to complete a test to drive a car:

Goal 1: “drive a car”

Sub goal a: “start engine”

Sub goal b: “remove handbrake”

Sub goal c: “engage first gear”

Sub goal c(1): “push gear stick to the left”

Sub goal n:

Goals can be stored in a knowledge base as well as situations and therefore the testing application (205) is aware of expected patterns.

B.1. Completion of Goals

In order to establish whether a goal has completed, the final output event associated with that goal must be known. A goal can only have a single final output event (and therefore, a single state). If differing final output events are required, each of the final output events must be associated with a different goal. Furthermore, since a goal has a single final output event, that final output event must not occur multiple times in the same goal. This is because the first occurrence of the output event would be indistinguishable from subsequent occurrences. Therefore, if multiple identical output events are required, each output event must be associated with a different goal.

It is also important to know whether a goal has successfully completed. There are many reasons for failure to complete, for example, if an output event has not been received by the testing application (205) within a “reasonable” time period, it can be concluded that the goal has failed.

Examples of a successful/failed goal include:

Success—if a final output event is produced, the goal has succeeded.

Failure—if a final output event is not produced, the goal has failed.

Failure—if an unrecognised output event is received, the goal has failed.

B.2. Reuse of Goals

An important advantage of the present invention is to reuse and exchange information between systems and testers. Therefore, heterogeneous systems must be handled.

In a preferred embodiment, the function to “generalise goals” is provided. In one embodiment, two goals for specific functions, namely, “Drive to work” and “Drive to school” can be generalised by creating a “Drive to “X”” goal. This general goal comprises “common” sub-goals (e.g. start the engine). Testing systems can use the general goal and insert unique sub-goals as required. In another embodiment, a goal that is the most comprehensive, or the most frequently used is kept in the store. Again, this allows particular systems to replace sub-goals with the required version.

B.3. Maintenance of Goals

To make the testing application user-friendlier, a preferred implementation utilises “labels” (i.e. names) for each goal so as to identify the function of each goal. Thus structures built up from labelled goals map well to human understanding of a process. Labelling will also facilitate documentation and maintenance. It is important that labels are “translated” between different environments and heterogeneous systems. For example, a goal labelled “Open a file called Fred” will not complete in a system requiring a goal labelled “Open a file named Bert”. This problem is overcome by utilising the goal generalisation principle outlined in B.2.

B.4. Advantages of Goal Structure.

It is possible to detect two useful pieces of information from a set of goals. Firstly, if a goal or sub-goal does not produce a final output event, the testing application can seek additional information at the point of failure. Secondly, if at any stage of the test plan, there is no progress in the goals or if known output events are being repeated and nothing else is changing, then a loop has occurred.

In some cases, a repeated goal is valid and therefore, in a preferred implementation, the testing application (205) is programmed to assume that a loop has occurred after a threshold has been reached. For example, after a certain number of repetitions has been reached. Therefore, it is an advantage of the present invention to detect loops by checking for progress within situations or new responses.

It should be understood that although the preferred embodiment has been described within a networked client-server environment, the present invention could be implemented in any environment. For example, the present invention could be implemented in a stand-alone environment whereby a testing application running on a computer machine tests an application program or a hardware component associated with the same machine. Furthermore, although two storage units (525 and 540) have been described, it should be understood that the present invention could be implemented by utilising one or more storage units.

It will be apparent from the above description that, by using the techniques of the preferred embodiment, a method for extracting data for re-use is provided. Information can be re-used between systems and between testers and this has many applications. For example, a tester can reuse knowledge to create test cases whereby known input events produce known output events so that less time is spent in preparing test cases. In another example, a testing application can handle new scenarios by utilising existing information from past scenarios. In yet another example, a testing application can handle new combinations of known scenarios, by referring to a knowledge base of known scenarios.

In summary, the present invention provides all the advantages associated with automated testing, such as, repeatability; speed; coverage of a higher proportion of the system or software under test and the ability to leave the tests to run unattended. However, it also provides flexibility, reduces maintenance overhead and promotes reuse.

1. A system for recording for reuse, at least one test event and at least one associated response, said system comprising: an application program for testing at least one function of a component to be tested:
a communication protocol for sending by said application program, said at least one test event to said component and receiving from said component, said at least one associated response;
storage for storing by a tracer, said at least one test event and said at least one associated response, in a trace file;
an analyser for analysing said trace file;
an extractor for extracting at least one minimum set of test events from said trace file, wherein said at least one minimum set generates said at least one associated response; and
said storage being further adapted to store said at least one minimum set and said at least one associated response.

2. A system as claimed in claim 1, in which said analyser comprises means for determining whether said trace file is empty.

3. A system as claimed in claim 1, in which said analyser comprises means for parsing said at least one test event.

4. A system as claimed in claim 1, in which said analyser comprises means for creating at least one reusable program comprising said at least one minimum set and said at least one associated response.

5. A system as claimed in claim 4, in which said analyser comprises means for adding said at least one reusable program to said storage.

6. A system as claimed in claim 1, in which two or more reusable programs share said at least one test event.

7. A system as claimed in claim 6, in which if said shared at least one test event generates two or more associated responses, said system further comprises means for invoking a rule for logging one of said two or more reusable programs.

8. A system as claimed in claim 1, in which said component to be tested is at least one of a hardware component or a software component.

9. A method for recording for reuse, at least one test event and at least one associated response, for use in a system comprising: an application program for testing at least one function of a component to be tested, said method comprising the steps of:
sending by said application program, said at least one test event to said component and receiving from said component, said at least one associated response;
storing said at least one test event and said at least one associated response in a trace file;
analysing said trace file;
extracting at least one minimum set of test events from said trace file, wherein said at least one minimum set generates said at least one associated response; and
storing said at least one minimum set and said at least one associated response.

10. A method as claimed in claim 9, in which said analysing step further comprises a step of determining whether said trace file is empty.

11. A method as claimed in claim 9, in which said analying step further comprises a step of parsing said at least one test event.

12. A method as claimed in claim 9, in which said analysing step further comprises a step of creating at least one reusable program comprising said at least one minimum set and said at least one associated response.

13. A method as claimed in claim 12, in which said analysing step further comprises a step of adding said at least one reusable program to said storage.

14. A method as claimed in claim 9, in which two or more reusable programs share said at least one test event.

15. A method as claimed in claim 14, in which if said shared at least one test event generates two or more associated responses, said method further comprises a step of invoking a rule for logging one of said two or more reusable programs.

16. A method as claimed in claim 9, in which said component to be tested is at least one of a hardware component or a software component.

17. A computer program comprising program code means adapted to perform all the steps of claim 9 when said program is run on a computer.
